(19) United States
(12) Patent Application Publication
(10) Pub. No.: US 2002/0029289 A1
(43) Pub. Date: Mar. 7, 2002

(54) Debugging of multiple data processors

(76) Inventors: Michael A. Byrne, Navan (IE); John J. Horrigan, Dublin (IE); William G. Jacob, Dublin (IE); Thomas Moore, Dublin (IE); Martin Jude O' Riordan, Maynooth (IE)

Correspondence Address: JACOBSON HOLMAN, PROFESSIONAL LIMITED LIABILITY COMPANY, 400 SEVENTH STREET, N.W., WASHINGTON, DC, 20004, US

(21) Appl. No.: 09/917,237

(22) Filed: Jul. 30, 2001

Related U.S. Application Data
(60) Provisional application No. 60/293,225, filed on May 25, 2001.

(30) Foreign Application Priority Data
Jul. 28, 2000 (IE) S2000/0603
Jan. 8, 2001 (IB) PCT/IE01/00002

(51) Int. Cl. G06F 15/173; G06F 15/16

(52) U.S. Cl. 709/238; 709/203; 709/200

(57) ABSTRACT

A router (2) in an integrated circuit (1) interfaces between a debug host (3) and a number N+1 of data processors (X10) and a TAP Controller (18). Data processor selection is dynamically in response to a SELX command from the debug host (3). Monitoring logic (19) determines length the combined data path and instruction/data memory fields of host commands, in order to extract the address which informs a multiplexer (15), which then synchronises signals accordingly. A switch multiplexer (16) bypasses the data processor multiplexer (15) for direct communication with control processors such as a TAP Controller (18).

### INTRODUCTION

1. Field of the Invention

The invention relates to routing of host signals to multiple data processors. The processors may reside on a single chip (“system-on-chip”) or they may be separate. The host may, for example, be a debug host.

2. Prior Art Discussion

The task of accessing multiple processors has heretofore been achieved by use of a bus or other common resource such as a memory to which each processor has access as a “master”. Typically, an arbitration circuit governs which master has access according to an arbitration scheme. While this approach is effective in some situations, in others it imposes undesirable complexity.

The invention is therefore directed towards providing for simpler routing of signals to multiple data processors.

### SUMMARY OF THE INVENTION

According to the invention, there is provided a router for routing signals between a host and a plurality of processors in a system, characterised in that, the router comprises:

a host channel for linking the router to the host;

a plurality of processor channels each for linking the router to one of the processors;

routing means comprising means for routing host commands to a selected processor and for routing responses from the selected processor to the host; and

selection means in the router for selecting a processor by monitoring the host commands, identifying a host selection command by detecting a flag in the command, and reading an address for a selected processor in the host selection command.

In one embodiment, the selection means comprises means for reading an address from an address field in a host selection command.

In another embodiment, the router comprises means for synchronising with a selected processor by monitoring an incoming command stream and an outgoing response, and for determining the total width of the fields of a host command, specific to width configurations of the processor.

In a further embodiment, the synchronisation means comprises means for determining the combined data path width and memory width of the selected processor according to data path and memory field widths in a host command.

In one embodiment, the synchronisation means comprises means for monitoring a next host command following a selection host command to determine a width parameter of the selected processor.

In another embodiment, the routing means comprises a multiplexer comprising means for routing communication between the host and the selected processor, and the selection means comprises monitoring logic for monitoring incoming host commands and writing a selected processor address to a register for said multiplexer.

In one embodiment, the synchronisation means comprises monitoring logic for monitoring incoming host commands and outgoing responses, and for writing synchronisation data to a register for said multiplexer.

In another embodiment, said multiplexer is connected to processor channels for data processors, and the router comprises a switch comprising means for acting in response to a control input from the host to route host commands to control processors, bypassing the multiplexer.

In a further embodiment, the router and the processors reside on a single system-on-chip integrated circuit.

In one embodiment, the host commands are debug host commands, and the router comprises means for routing debug responses to the host.

According to another aspect, the invention provides a system-on-chip integrated circuit comprising:

a plurality of data processors;

at least one control processor;

a router for routing signals between on external host and said processors, the router comprising:

host channel for linking the router to the host;

a plurality of processor channels each for linking the router to one of the data processors;

routing means comprises means for routing signals between a selected data processor and the host;

selection means comprising means for monitoring incoming host commands on the host channel to identify a host selection command, for reading an address of a selected data processor from an identified host selection command, and for informing the routing means of the selected data processor address;

synchronisation means comprising means for monitoring incoming host commands on the host channel and outgoing responses from the data processor, for determining width of a field of a host command, and for determining a combined width parameter of the selected data processor according to said field width, and for informing the routing means of the width parameter;

means in the routing means for synchronising signals between the host and the selected data processor according to said width parameter; and

a switch comprising means for bypassing host command signals received on the host channel from the routing means, and for routing them directly to the control processor.

In one embodiment, said switch comprises means for bypassing said signals in response to a control input from the host.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagram illustrating a router and the channels to which it is connected;

FIG. 2 is a diagram illustrating the router in more detail;

FIG. 3 is a diagram illustrating a selection host command; and

FIG. 4 is a diagram illustrating timing of a response from a currently addressed processor with respect to a n incoming command sequence from a host.

### DESCRIPTION OF THE EMBODIMENTS

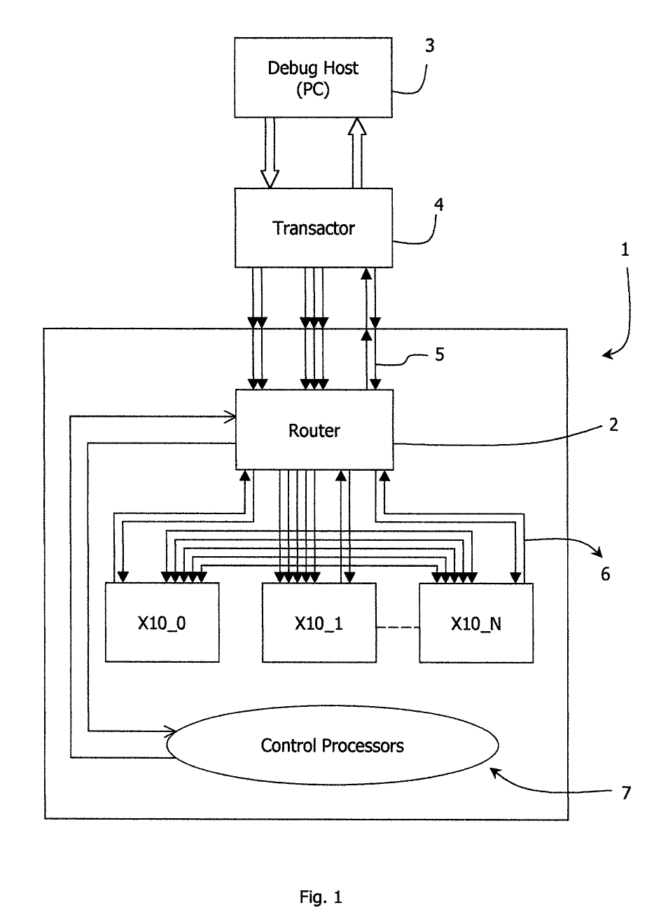

Referring to FIG. 1 a single chip system 1 comprises N+1 “X10” processors, and a router 2. The router 2 is an internal block on the chip 1 acting as an interface between the (internal) X10 processors and an external debug host 3 via a transactor 4. The transactor 4 is for converting commands from the debug host 3 into a format understood by the processors. The internal processors comprise “X10” data processors and also control processors 7 in the rest of the system-on-chip 1. The word “control processor” is intended to cover any control functions such as a test controller.

The router 2 has conductor channels 5 for communication with the transactor 4 on one side, and a set of channels 6 linking it with each processor.

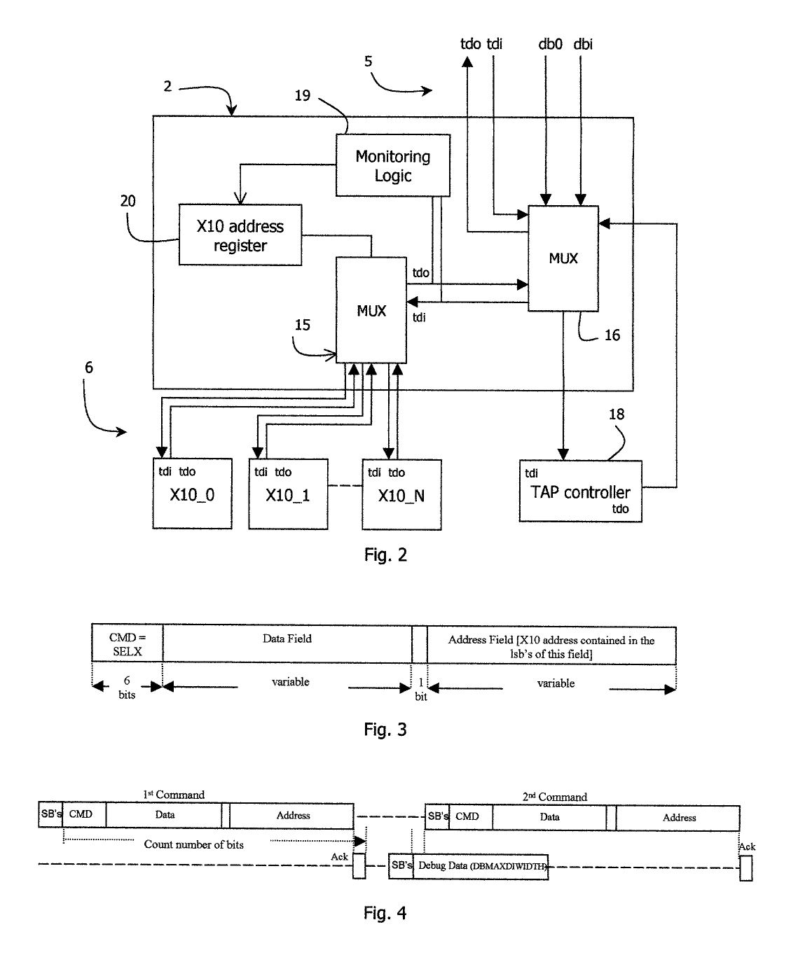

Referring to FIG. 2, the router 2 comprises a multiplexer 15 connected to the channels 6. Each channel 6 comprises a pair of conductors, “tdi” for incoming streams and “tdo” for outgoing streams. The router 2 also comprises a multiplexer 16 which routes tdo and tdi to and from the multiplexer 15. It is also linked by a tdi/tdo channel to a TAP controller 18 in the chip 1.

The host channel 5 comprises a pair of tdi/tdo conductors, and also a pair of selection conductors db0 and db1 for the multiplexer 16.

Thus, the tdi route through the router 2 is used for incoming commands from the host, whereas the tdo route is used for outgoing responses from either an X10 processor or another block, such as a TAP controller 18.

For dynamic determination of the addressed X10 processor the router comprises monitoring logic 19 connected to the tdi input and the tdo output from multiplexer 15, and an X10 address register 20.

A function of the router 2 is to determine which X10 the debug host 3 wishes to communicate with and to route debug commands accordingly. It does this by monitoring the signals coming from the transactor 4 for a selection (SELX) command which tells the router 2 which X10 the debug host wishes to communicate with. Once a SELX command has been recognised by the router 2, it switches the lines of communication to the X10 that has been requested in the SELX command. Then any further communication from the host 3 is routed to that particular X10, and the responses from that X10 are routed directly back to the host 3. Thus, the router 2 controls full bi-directional communication in response to a detected SELX command.

If the debug host 3 wishes to address another X10 on the system, it sends another SELX command, specifying the address of the next X10 it wishes to communicate with, and the router again routes the commands to the required X10, and routes its responses back to the host 3.

The X10 processors may have different features. From a debug perspective, the features that are most relevant are:

The data-path width, called DWIDTH

The length of the data memory address, called DAWIDTH

The length of the instruction memory address, called IAWIDTH

DWIDTH determines the size of the internal storage registers of the X10. It also determines the width of the word stored in the data memory. DAWIDTH specifies the size of the data memory attached to the X10. The number of words of data stored in the data memory is given by 2^{DAWIDTH}. IAWIDTH specifies the size of the instruction memory. The number of instruction words stored in the instruction memory is given by 2^{IAWIDTH}.

The debug host 3 communicates with the X10's by sending out debug commands incorporating data. The X10 responds by sending back data packets. Referring to FIG. 3, a debug command is made up of the following:

A command field, 6 bits long.

A data field, which is IAWIDTH, IWIDTH or DWIDTH bits long, depending on which value is greatest (where the IAWIDTH, IWIDTH and DWIDTH used matches the those of the particular X10 being addressed by the debug host 3)

A bit which selects between instruction memory and data memory

An address field, which is either DAWIDTH bits long or IAWIDTH bits long, depending on which value is greater (where the DAWIDTH and IAWIDTH used match those of the particular X10 being addressed by the Debug Host).

In more detail, when the debug host 3 wishes to communicate with a particular X10 processor on the chip, it firstly must issue a SELX command, the format of which is shown in FIG. 3, in which it specifies the address of the processor with which is wants to initiate communication. The address of the X10 is specified in the LSBs of the Address field of the SELX command. Since the commands are transmitted serially, these are the last bits of the sequence received by the router 2.

The logic 19 continuously monitors the tdi input and the tdo output from multiplexer 15. When two start bits are identified it reads the next 6 command bits. The logic 19 then determines the address of the next X10 by reading the address field LSBs. The next X10 address is written to the register 20 which controls the multiplexer 15. The multiplexer 15 then routes further communication from the host 3 to the required X10 processor, and the responses from that processor back to the host, until another SELX command requesting a different X10 processor is received.

Each X10 processor can have different data and address features, as set out above. The debug host 3 is programmed with the features of the X10 processors, and uses these address and data features in the address and data fields of its commands, as shown in FIG. 3. Hence, the command length used by the host to communicate with one X10 could be different from the command length used by the host 3 when communicating with another X10.

However, the router 2 is not programmed with the features of the X10 processors to which it is connected. The router 2 dynamically determines the combined length of the data and address fields of the next incoming command after a SELX command. When an X10 receives a valid command from the host via the transactor 4 and the router 2, it responds by transmitting an acknowledge message on its tdo channel (ACK), as shown in FIG. 4. The time between the start of the command sequence issued by the host on the tdi input, and the ACK issued by the X10 on the tdo is always equal to 7 bits plus the combined length of the address and data fields.

This logic 19 actually monitors both the incoming tdi, and the tdo output from the Multiplexer 15. On receipt of two start bits on tdi it counts the number of clock cycles until an ack is received on tdo and it then registers this count value. This count is then used to synchronise with any subsequent commands until another SELX command is received.

Therefore, in order to determine the length of the command sequence, the router 2 counts the number of cycles from the start of the command sequence (which is indicated by two start bits, SB's, which it can easily recognise), to the time when the X10 responds with its ACK message. Once the router 2 has determined this value, it then knows the combined address and data features of that X10 for synchronisation purposes.

Each time the debug host 3 issues a command, the router 2 carries out the same task of extracting the address of the selected processor from the command. However, the width is only updated after a SELX command. So, it does not matter if all the X10's have the same or different features—the router checks every time anyway.

Two input pins on the router 2, db0 and db1, are used by the host to allow the debug host 3 or another host to use the same interface. Examples of this include JTAG testing of the system-on-chip. In more detail, the db0 and db1 pins control the multiplexer 16. These pins configure the multiplexer 16 such that communication is no longer routed to an X10 processor on the system-on-chip, but to another separate “control processor” block in the system 1 which is connected to the router 2. The db0 and db1 pins cause the multiplexer 16 to by-pass the multiplexer 15, linking the tdo and tdi channels 5 to the TAP Controller 18. The TAP controller 18 carries out specialised tasks such as running specific JTAG (Joint Test Action Group) tests in the system. The TAP controller then can send the results of its tests out via the channel 5.

It will be appreciated that the invention facilitates the control, monitoring and debugging of multiple processors in a system through a single interface.

Monitoring of the SELX command is an effective way to inform the router 2 which X10 processor the host 3 wishes to debug.

Another advantage of the router 2 is that it allows the debug host 3 to communicate with many instances of X10's, each of which possibly has a different configuration by dynamically determining the length of the command/data packets the debug host 3 uses to communicate with each X10 in the system. It does this in order to synchronise the communication between the X10 being addressed and the debug host. The multiple multiplexer arrangement also allows excellent flexibility in terms of the range of functions in the system which can be easily accessed. It provides this flexibility without adding significant complexity to the system because it allows configuration control memory and logic to be kept external, on the host.

The invention is not limited to the embodiments described but may be varied in construction and detail. For example, the router may be used for routing commands from a host other than a debug host. Also, the host may be on-chip or off-chip.

1. A router for routing signals between a host (3) and a plurality of processors (X10) in a system (1), characterised in that, the router comprises:
a host channel (5) for linking the router to the host;
a plurality of processor channels (6) each for linking the router to one of the processors (X10);
routing means (15) comprising means for routing host commands to a selected processor and for routing responses from the selected processor to the host (3); and
selection means (19) in the router (2) for selecting a processor (X10) by monitoring the host commands, identifying a host selection command by detecting a flag in the command, and reading an address for a selected processor in the host selection command.

2. A router as claimed in claim 1, wherein the selection means (19) comprises means for reading an address from an address field in a host selection command.

3. A router as claimed in claim 1, wherein the router comprises means for synchronising with a selected processor (X10) by monitoring an incoming command stream and an outgoing response, and for determining the total width of the fields of a host command, specific to width configurations of the processor.

4. A router as claimed in claim 3, wherein the synchronisation means (19) comprises means for determining the combined data path width and memory width of the selected processor according to data path and memory field widths in a host command.

5. A router as claimed in claim 3, wherein the synchronisation means (19) comprises means for monitoring a next host command following a selection host command to determine a width parameter of the selected processor.

6. A router as claimed in claim 1, wherein the routing means comprises a multiplexer (15) comprising means for routing communication between the host and the selected processor (X10), and the selection means comprises monitoring logic (19) for monitoring incoming host commands and writing a selected processor address to a register (20) for said multiplexer.

7. A router as claimed in claim 6, wherein the synchronisation means comprises monitoring logic (19) for monitoring incoming host commands and outgoing responses, and for writing synchronisation data to a register (20) for said multiplexer (15).

8. A router as claimed in claim 6, wherein said multiplexer (15) is connected to processor channels (6) for data processors, and the router comprises a switch (16) comprising means for acting in response to a control input from the host (3) to route host commands to control processors (18), bypassing the multiplexer (15).

9. A router as claimed in claim 1, wherein the router (2) and the processors (X10) reside on a single system-on-chip integrated circuit.

10. A router as claimed in claim 1, wherein the host commands are debug host commands, and the router comprises means for routing debug responses to the host.

11. A system-on-chip integrated circuit (1) comprising:
a plurality of data processors (X10);
at least one control processor (18);
a router (2) for routing signals between on external host (3) and said processors (X10), the router comprising:
a host channel (5) for linking the router to the host (3);
a plurality of processor channels (6) each for linking the router (2) to one of the data processors (X10);
routing means (15) comprises means for routing signals between a selected data processor (X10) and the host;
selection means comprising means for monitoring incoming host commands on the host channel (5) to identify a host selection command, for reading an address of a selected data processor from an identified host selection command, and for informing (19, 20) the routing means (15) of the selected data processor address;
synchronisation means (19) comprising means for monitoring incoming host commands on the host channel (5) and outgoing responses from the data processor, for determining width of a field of a host command, and for determining a combined width parameter of the selected data processor according to said field width, and for informing the routing means (15) of the width parameter;
means in the routing means (15) for synchronising signals between the host and the selected data processor according to said width parameter; and
a switch (16) comprising means for bypassing host command signals received on the host channel (5) from the routing means (15), and for routing them directly to the control processor (18).

12. A system-on-chip integrated circuit as claimed in claim 11, wherein said switch (16) comprises means for bypassing said signals in response to a control input from the host.
